(19) United States
(12) Patent Application Publication
(10) Pub. No.: US 2024/0255316 A1
(43) Pub. Date: Aug. 1, 2024

(54) POSITION DETECTION DEVICE

(71) Applicant: Proterial, Ltd., Tokyo (JP)

(72) Inventors: Yohei SHIRAKAWA, Tokyo (JP); Yoshiaki YANAGISAWA, Tokyo (JP); Yoshitake AGEISHI, Tokyo (JP); Yukio IKEDA, Tokyo (JP); Masanori SAGAWA, Tokyo (JP)

(21) Appl. No.: 18/420,288

(22) Filed: Jan. 23, 2024

(30) Foreign Application Priority Data
Jan. 27, 2023 (JP) 2023-010653

(51) Int. Cl. G01D 5/20; B62D 15/02

(52) U.S. Cl. CPC G01D 5/2053; B62D 15/0225

(57) ABSTRACT

A position detection device for detecting a position of a moving member moving forward and backward in a predetermined moving direction is provided with a detection object provided at the moving member, a substrate provided with an excitation coil for generating a magnetic field in an area including the detection object, and a detection coil being interlinked with a magnetic flux of the magnetic field, a power supply unit for supplying an alternating current to the excitation coil, a calculation unit that calculates the position of the moving member based on an output voltage of the detection coil, and a magnetic field diffusion suppression member for suppressing a spread of a magnetic field generated by energization to the excitation coil.

### CROSS-REFERENCE TO RELATED APPLICATIONS

The present patent application claims the priority of Japanese patent application No. 2023-010653 filed on Jan. 27, 2023, and the entire contents thereof are hereby incorporated by reference.

### TECHNICAL FIELD

The present invention relates to a position detection device that detects the position of a moving member that moves forward and backward in a predetermined direction.

### BACKGROUND OF THE INVENTION

Conventionally, a position detection device that detects the position of a shaft that moves forward and backward (i.e., reciprocating) in the axial direction is being used, for example, to detect the position of a rack shaft in a steering device of a vehicle.

A detection unit described in Patent Literature 1 detects an axial position of a rack shaft of an electric power steering device and includes a DC power source, a permanent magnet, an element group composed of first to fourth magnetoresistive elements disposed between the permanent magnet and the rack shaft, and a calculation unit for calculating the position of the rack shaft. In the element group, a series circuit including the first and second magnetoresistive elements being connected in series, and a series circuit including the third and fourth magnetoresistive elements being connected in series are connected in parallel to form a bridge circuit. To the calculation unit, a potential of a first terminal connected between the first magnetoresistive element and the second magnetoresistive element and a potential of a terminal connected between the third magnetoresistive element and the fourth magnetoresistive element are input. Plural grooves extending in a direction inclined with respect to the axial direction of the rack shaft are formed on the surface of the rack shaft facing the element group.

In the detection unit configured as described above, when the rack shaft moves in the axial direction due to the rotation of the pinion gear shaft meshing with the rack shaft and the relative positions of the first to fourth magnetoresistive elements with respect to the grooves change, the electric resistance balance of the first to fourth magnetoresistive elements changes, so that the potentials of the first terminal and the second terminal change. The calculation unit calculates the position of the rack shaft based on changes in these potentials.

### CITATION LIST

Patent Literature 1: WO2021/210125

### SUMMARY OF THE INVENTION

In the detection unit disclosed in Patent Literature 1, if the distribution of the magnetic field of the permanent magnet is affected by, for example, steel materials of a vehicle body placed around the detection unit, the detected rack shaft position may have an error. Accordingly, it is an object of the present invention to provide a position detection device capable of suppressing the decline in position detection accuracy.

To solve the problems mentioned above, the present invention provides: a position detection device for detecting a position of a moving member moving forward and backward in a predetermined moving direction, comprising:
a detection object provided at the moving member;
a substrate provided with an excitation coil for generating a magnetic field in an area including the detection object, and a detection coil being interlinked with a magnetic flux of the magnetic field;
a power supply unit for supplying an alternating current to the excitation coil;
a calculation unit that calculates the position of the moving member based on an output voltage of the detection coil; and
a magnetic field diffusion suppression member for suppressing a spread of a magnetic field generated by energization to the excitation coil.

### Effects of the Invention

According to the position detection device according to the present invention, it is possible to suppress the decline in position detection accuracy.

### BRIEF DESCRIPTION OF DRAWINGS

FIG. 1 is a schematic diagram of a vehicle equipped with a steer-by-wire steering device having a stroke sensor as a position detection device, according to an embodiment of the present invention.

FIG. 2 is a cross-sectional view of a rack shaft, a housing, a target, a case member, a substrate, and a shield conductor taken along line A-A in FIG. 1.

FIG. 3 is a perspective view showing the target, the substrate, the shield conductor, a CPU, the case member, the rack shaft, and a part of the housing.

FIG. 4 is an overall view of wiring patterns formed on the first to fourth metal layers of the substrate seen through from a front surface side.

FIGS. 5A to 5D are plan views, respectively showing the first to fourth metal layers viewed from the front surface side.

FIG. 6 is a graph showing the relationship between a supply voltage supplied from a power supply unit to an excitation coil, an induced voltage induced in the sine wave-shaped detection coil, and an induced voltage induced in a cosine wave-shaped detection coil.

FIG. 7 is an explanatory diagram schematically showing the relationship between a peak voltage, which is a peak value of the induced voltage induced in the sine wave-shaped detection coil, and the position of the target.

FIG. 8 is an explanatory diagram schematically showing the relationship between a peak voltage, which is a peak value of the induced voltage induced in the cosine wave-shaped detection coil, and the position of the target.

FIG. 9 is a cross-sectional view of a shield conductor according to the first modified example and its peripheral parts.

FIG. 10 is a perspective view showing the shield conductor according to the first modified example, together with the target, the substrate, the CPU, the case member, the rack shaft, and a part of the housing.

FIG. 11 is a cross-sectional view of a pair of magnetic elements as magnetic field diffusion suppression member according to the second modified example and its peripheral parts.

FIG. 12 is a perspective view showing the pair of magnetic elements according to the second modified example, together with the target, the substrate, the CPU, the case member, the rack shaft, and a part of the housing.

### DETAILED DESCRIPTION OF THE INVENTION

### Embodiments

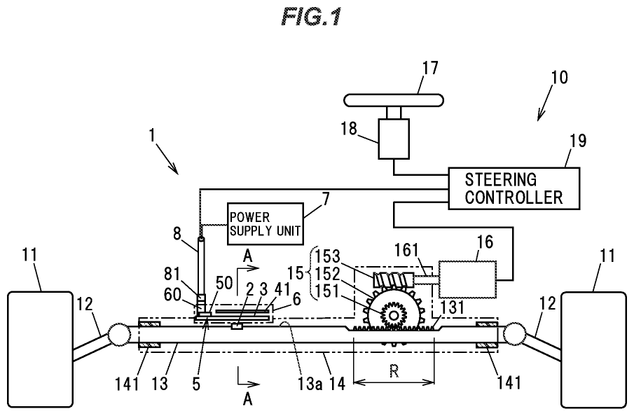

FIG. 1 is a schematic diagram of a vehicle equipped with a steer-by-wire steering device 10 having a stroke sensor 1 as a position detection device according to an embodiment of the present invention. In FIG. 1, the steering device 10 is shown viewed from a rear side in a front-rear direction, with the right side of the drawing corresponding to the right side in the vehicle width direction and the left side of the drawing corresponding to the left side in a vehicle width direction.

As shown in FIG. 1, the steering device 10 comprises a stroke sensor 1, tie rods 12 connected to steerable wheels 11 (left and right front wheels), a rack shaft 13 connected to the tie rods 12, a cylindrical housing 14 for accommodating the rack shaft 13, a worm reduction mechanism 15 having a pinion gear 151 meshed with a rack teeth 131 of the rack shaft 13, an electric motor 16 that imparts axial movement force to the rack shaft 13 via the worm reduction mechanism 15, a steering wheel 17 to be operated by the driver, a steering angle sensor 18 for detecting a steering angle of the steering wheel 17, and a steering controller 19 for controlling the electric motor 16 based on the steering angle detected by the steering angle sensor 18.

The rack shaft 13 is a moving member whose position relative to the housing 14 is detected by the stroke sensor 1. The moving direction of the rack shaft 13 is in an axial direction parallel to a central axis O of the rack shaft 13.

In FIG. 1, the housing 14 is shown in a virtual line (phantom). The rack shaft 13 is supported by a pair of rack bushings 141 attached to both ends of the housing 14. The worm reduction mechanism 15 has a worm wheel 152 and a worm gear 153, and the pinion gear 151 is attached to the worm wheel 152. The worm gear 153 is attached to a motor shaft 161 of the electric motor 16.

The electric motor 16 generates torque by a motor current supplied from the steering controller 19 and rotates the worm wheel 152 and the pinion gear 151 via the worm gear 153. When the pinion gear 151 rotates, the rack shaft 13 moves forward and backward in its axial direction, and the left and right steerable wheels 11 are steered. The rack shaft 13 can move rightward and leftward in the vehicle width direction within a predetermined range from a neutral position when the steering angle is zero.

In FIG. 1, a stroke range R, which corresponds to the maximum travel distance of the rack shaft 13 when the steering wheel 17 is steered from the maximum steering angle of one side to the other, is indicated by double arrows. The stroke sensor 1 can detect the absolute position of the rack shaft 13 relative to the housing 14 over this entire stroke range R.

### (Structure of Stroke Sensor 1)

The stroke sensor 1 includes a target 2 as a detection object attached to the rack shaft 13, a substrate 3 arranged to face the target 2, a shield conductor 41 as a magnetic field diffusion suppression member positioned parallel to the substrate 3, a calculation unit 5 having a CPU (arithmetic processing unit) 50 mounted on the substrate 3, a case member 6 having a connector 60, a power supply unit 7 generating high-frequency voltage, and a cable 8 for connecting the connector 60 mounted on the case member 6 to the power supply unit 7 and a steering controller 19. The substrate 3 is housed in the case member 6 and positioned parallel to the moving direction of the rack shaft 13, and is fixed to the housing 14 in a non-movable manner.

The stroke sensor 1 detects the axial (moving direction) position of the rack shaft 13 relative to the housing 14 and outputs the detected position information to the steering controller 19 via the cable 8. The steering controller 19 controls the electric motor 16 in such a manner that the position of the rack shaft 13 detected by the stroke sensor 1 corresponds to the steering angle of the steering wheel 17 detected by the steering angle sensor 18.

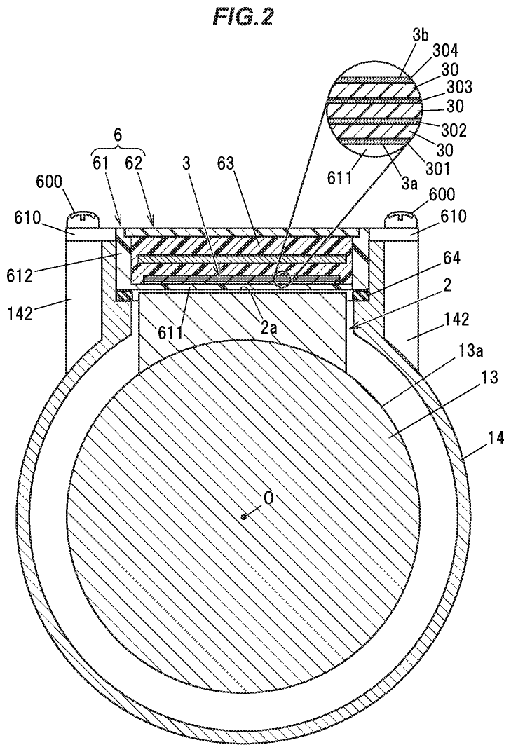

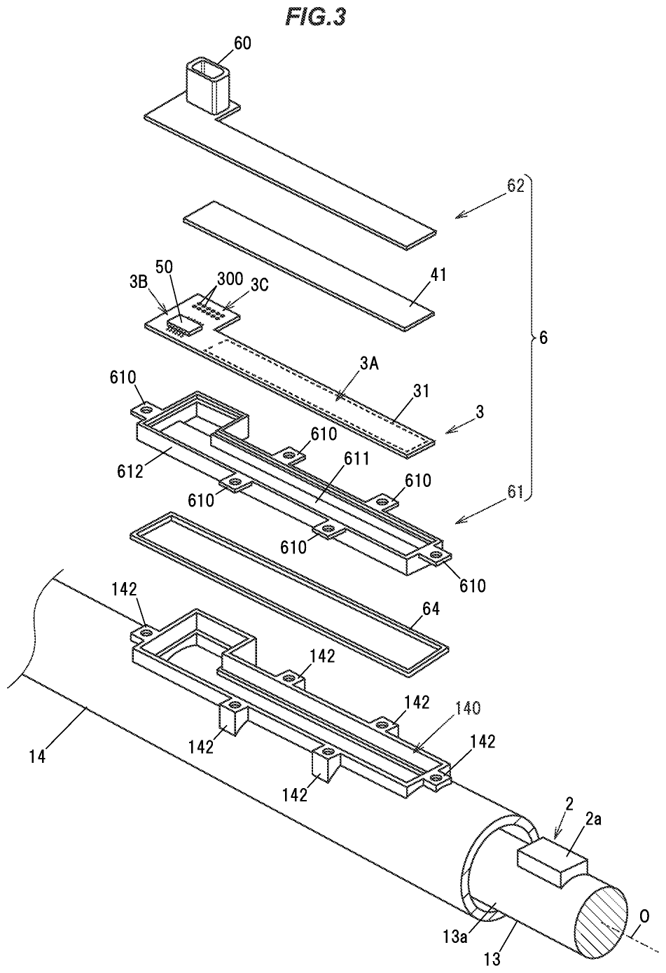

FIG. 2 is a cross-sectional view taken along line A-A in FIG. 1. FIG. 3 is a perspective view showing the target 2, the substrate 3, the shield conductor 41, the CPU 50, the case member 6, the rack shaft 13, and a part of the housing 14.

The rack shaft 13 is a rod-shaped body with a circular cross-section made of steel, such as carbon steel for machine structural purposes. The housing 14 is made of a tubular aluminum alloy, for example, die-cast and molded. The housing 14 has an opening 140 opening vertically upward, and a case member 6 is attached to the housing 14 to close the opening 140.

The target 2 is a target for showing the position of the rack shaft 13 with respect to the stroke sensor 1. In the present embodiment, the target 2 is fixed to the outer peripheral surface 13a of the rack shaft 13 by welding, but a fixing method of the target 2 is not limited thereto. For example, the target 2 may be fixed to the rack shaft 13 by bolting.

The target 2 is rectangular parallelepiped (cuboid) in shape that is lengthy in the axial direction of the rack shaft 13 when viewed from a substrate 3-side. A facing surface 2a of the target 2, which faces the substrate 3, is formed in a flat shape. A non-magnetic metal such as an aluminum alloy or copper, which has a higher conductivity than the rack shaft 13, can be suitably used as the material of the target 2. Iron may also be used as the material of the target 2, and the conductivity of the target 2 may be the same as that of rack shaft 13. A protrusion on the rack shaft 13 may also be used as the target 2.

The case member 6 includes a case body 61, and a case lid 62, and a mold resin 63 is filled between the case body 61 and the case lid 62. The case body 61 and the case lid 62 are made of, e.g., a resin material as an insulator. The shield conductor 41 is made of electrically conductive metal, such as copper or aluminum, for example, and is formed as a flat plate shape, and is disposed between the substrate 3 and the case lid 62. Thus, in the present embodiment, the target 2 is placed on one side of the substrate 3 (front surface 3a-side) and the shield conductor 41 is placed on the other side of the substrate 3 (back surface 3b-side), among one side and the other side perpendicular to the substrate 3.

The substrate 3 and the shield conductor 41 are fixed in position in the case member 6 by the mold resin 63, and the distance between the shield conductor 41 and the back surface 3b of the substrate 3 is kept constant by the mold resin 63. The case body 61 has a bottom plate 611 on the front surface 3a-side of the substrate 3 and a circumferential wall 612 provided around the bottom plate 611. The substrate 3 has the front surface 3a in contact with the bottom plate 611. The case lid 62 is fixed to an opening end of the circumferential wall 612, for example by adhesion. The connector 60 is attached to the case lid 62. To the connector 60 is connected a connector 81 (see FIG. 1) of the cable 8 for connection to the power supply unit 7 and the steering controller 19.

The case body 61 has a plurality of fixing portions 610 for fixing to the housing 14, and these fixing portions 610 are fixed to fixed portions (i.e., fixing object portions) 142 in the housing 14 by bolts 600 (see FIG. 2). A packing 64 is disposed between the case body 61 and the housing 14 to prevent moisture from entering through the opening 140 of the housing 14.

The substrate 3 is a four-layered substrate in which layers of a plate-shaped base material 30 made of a dielectric material such as FR4 (glass fiber impregnated with epoxy resin and heat-cured) are provided between the first to fourth metal layers 301 to 304. The thickness of each base material 30 is, e.g., 0.3 mm. Each of the first to fourth metal layers 301 to 304 has a thickness of, e.g., 18 μm. The substrate 3 has a flat rectangular shape whose longitudinal direction is the axial direction of the rack shaft 13.

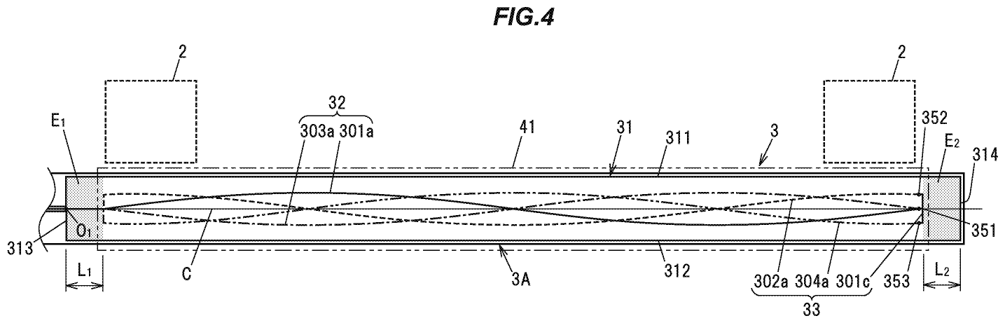

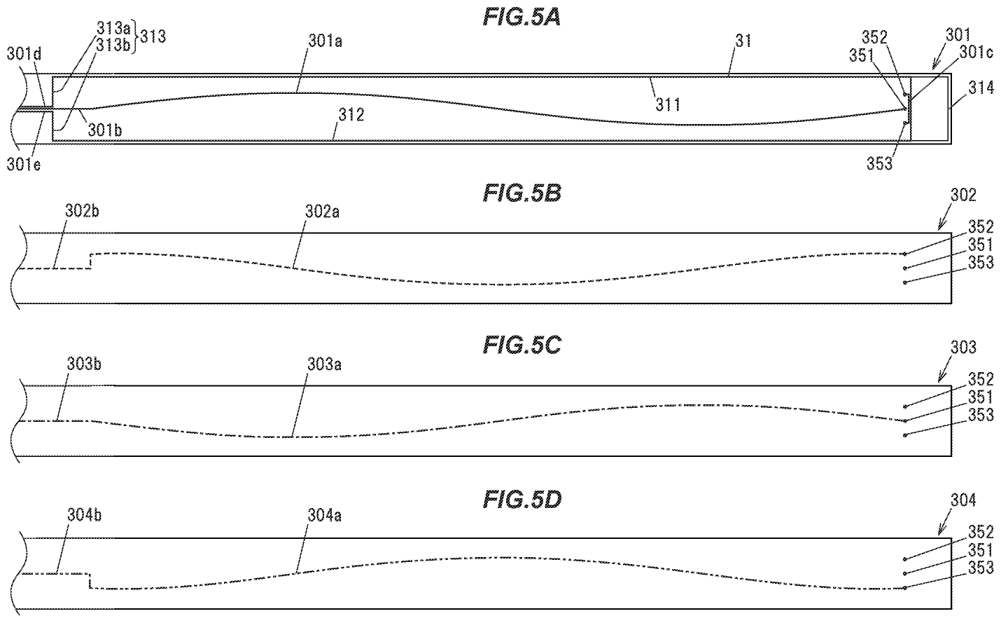

FIG. 4 is an overall view of the wiring patterns formed on the first to fourth metal layers 301 to 304 of the substrate 3 as seen through from the front surface 3a-side toward the back surface 3b-side. FIGS. 5A to 5D are plan views showing the first to fourth metal layers 301 to 304, respectively, viewed from the front surface 3a-side. The wiring patterns shown in FIGS. 4A and 4B and FIGS. 5A to 5D are merely examples, and various wiring patterns may be used as long as the substrate 3 is formed so as to obtain the effects of the present invention.

In FIG. 4 and FIGS. 5A to 5D, the wiring pattern of the first metal layer 301 is indicated by solid lines, the wiring pattern of the second metal layer 302 is indicated by broken lines, the wiring pattern of the third metal layer 303 is indicated by a one-dot chain line, and the wiring pattern of the fourth metal layer 304 is indicated by a two-dot chain line. In FIG. 4, the dotted lines indicate the positions of the target 2 when the rack shaft 13 is positioned at one end and the other end of the range in which the stroke sensor 1 can detect the absolute position of the rack shaft 13. Although the target 2 and the substrate 3 are aligned in the thickness direction of the substrate 3, in FIG. 4, the position of the target 2 is shown shifted in the vertical direction of the drawing.

The substrate 3 is formed with first to third vias 351 to 353 for interlayer connecting the wiring patterns of the first to fourth metal layers 301 to 304. The first metal layer 301 includes a first curved portion 301a, a first connector-connecting portion 301b connecting one end of the first curved portion 301a to the calculation unit 5, and an end-connecting portion 301c connecting respective ends of a second curved portion 302a to be described later and a fourth curved portion 304a. The second metal layer 302 includes the second curved portion 302a, and a second connector-connecting portion 302b connecting one end of the second curved portion 302a to the calculation unit 5. The third metal layer 303 includes a third curved portion 303a, and a third connector-connecting portion 303b connecting one end of the third curved portion 303a to the calculation unit 5. The fourth metal layer 304 includes a fourth curved portion 304a, and a fourth connector-connecting portion 304b connecting one end of the fourth curved portion 304a to the calculation unit 5.

The other ends of the first curved portion 301a and the third curved portion 303a are connected to each other by the first via 351. One end of the end-connecting portion 301c is connected to the other end of the second curved portion 302a by the second via 352, and the other end of the end-connecting portion 301c is connected to the other end of the fourth curved portion 304a by the third via 353.

The first to fourth curved portions 301a, 302a, 303a, and 304a are curved in a sine wave shape. The first curved portion 301a and the third curved portion 303a, and the second curved portion 302a and the fourth curved portion 304a are symmetrical about a central axis C parallel to the moving direction of the rack shaft 13, which is the axis of symmetry.

The substrate 3 includes an excitation coil 31 that generates a magnetic field in a range including the target 2, and two detection coils 32 and 33 with which the magnetic flux of the magnetic field generated by the excitation coil 31 interlinks. The excitation coil 31 and the two detection coils 32, 33 are formed in a portion that lines up in the thickness direction of the target 2 and the substrate 3 when the rack shaft 13 moves. Of the two detection coils 32 and 33, one detection coil 32 is formed by the first curved portion 301a and the third curved portion 303a, and the other detection coil 33 is formed by the second curved portion 302a, the fourth curved portion 304a, and the end-connecting portion 301c. The calculation unit 5 determines the position of the rack shaft 13 by calculation using the output voltages of the two detection coils 32 and 33. The CPU 50 of the calculation unit 5 has an arithmetic processing function that executes arithmetic procedures according to a program and an AD conversion (analog-to-digital conversion) function, and the output voltage of the detection coils 32, 33 is input to the CPU 50.

The excitation coil 31 has a rectangular shape having a pair of long side portions 311 and 312 extending in the axial direction of the rack shaft 13 and a pair of short side portions 313 and 314 between the pair of long side portions 311 and 312, and the detection coils 32, 33 are formed between the pair of long side portions 311 and 312. In FIG. 3, the shape of the excitation coil 31 is shown as a dashed line. The substrate 3 integrally comprises a coil portion 3A, which is the portion in which the excitation coil 31 and the detection coils 32, 33 are formed, a CPU mounting portion 3B, in which the CPU 50 is mounted, and a connector mounting portion 3C, in which a connector 60 is mounted. The connector mounting portion 3C has a plurality of through holes 300 through which connector pins of the connector 60 are inserted. The coil portion 3A is rectangular in shape and long in the direction of movement of the rack shaft 13.

In this embodiment, the long side portions 311 and 312 and the short side portions 313 and 314 are formed as wiring patterns on the first metal layer 301. Of the pair of short side portions 313 and 314, the short side portion 313 on the side of the connector portion 340 is composed of two straight portions 313a and 313b sandwiching the first to fourth connector-connecting portions 301b, 302b, 303b and 304b. The respective ends of the two straight portions 313a, 313b are electrically connected to connector pins of the connector 60 by means of the connector-connecting portions 301d, 301e formed in the first metal layer 301. The excitation coil 31 may be formed not only on the first metal layer 301 but also on any of the second to fourth metal layers 302 to 304 or may be formed over a plurality of layers.

A sine wave AC current is supplied to the excitation coil 31 from the power supply unit 7. Eddy currents are generated in the target 2 by the magnetic flux generated by the AC current supplied to the excitation coil 31. The magnetic field generated by this eddy current acts to weaken the magnetic field generated by the excitation coil 31, and the magnetic flux density in the part of the substrate 3 facing the target 2 becomes lower than in other parts. Induced voltage is generated in the two detection coils 32 and 33 by interlinking of the magnetic flux of the magnetic field generated by the excitation coil 31, and the peak value of the voltage induced in the detection coils 32 and 33 varies according to the position of the target 2 relative to the substrate 3. The peak value of the voltage refers to the maximum value of the absolute value of the voltage within a period of one cycle of the alternating current supplied to the excitation coil 31.

The phases of the voltages induced in the detection coils 32 and 33 are different from each other while the rack shaft 13 moves from one movement end in the axial direction to the other movement end in the axial direction. In this embodiment, the phases of the voltages induced in the detection coils 32 and 33 differ by 90°. Hereinafter, of the two detection coils 32 and 33, one detection coil 32 is referred to as a sine wave-shaped detection coil 32, and the other detection coil 33 is referred to as a cosine wave-shaped detection coil 33.

The peak value of the voltage induced in the sine wave-shaped detection coil 32 and the cosine wave-shaped detection coil 33 due to the interlinking of the magnetic flux of the target 2 changes within the range of one cycle or less while the rack shaft 13 moves one movement end to the other movement end in the axial direction. Thereby, the stroke sensor 1 can detect the absolute position of the rack shaft 13 over the entire range R₁ in which the rack shaft 13 can move in the axial direction.

As shown in FIG. 4, between respective ones of the pair of short side portions 313 and 314 of the excitation coil 31, the sine wave-shaped detection coil 32, and the cosine wave-shaped detection coil 33, there are provided first and second buffer regions E₁, E₂ for suppressing voltages induced in the sine wave-shaped detection coil 32 and the cosine wave-shaped detection coil 33 by the magnetic flux generated by the current flowing through the short side portions 313 and 314. In the example shown in FIG. 4, a length L₁ of the first buffer region E₁ and a length L₂ of the second buffer region E₂ in the longitudinal direction of the substrate 3 are the same, but L₁ and L₂ may be different from each other.

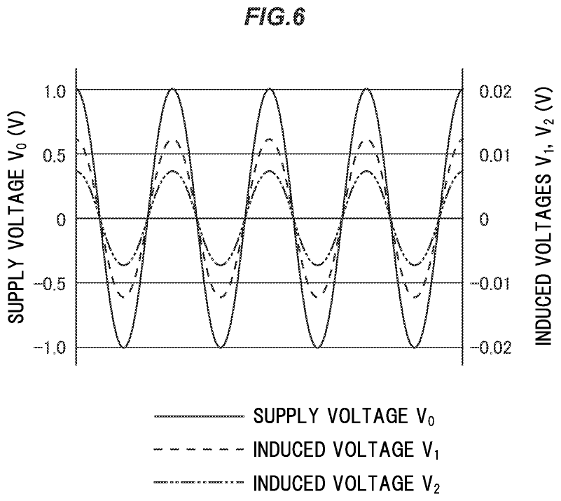

Next, the operation of the stroke sensor 1 for detecting the position of the target 2 with respect to the substrate 3 will be described with reference to FIGS. 6 to 8. In the following description, the position of the target 2 means the center position of the target 2 in the longitudinal direction of the substrate 3.

FIG. 6 is a graph showing the relationship between a supply voltage V₀ supplied from the power supply unit 7 to the excitation coil 31, an induced voltage V₁ induced in the sine wave-shaped detection coil 32, and an induced voltage V₂ induced in the cosine wave-shaped detection coil 33. The horizontal axis of the graph in FIG. 6 is the time axis, and the left and right vertical axes indicate the supply voltage V₀ and the induced voltages V₁ and V₂.

In the example shown in FIG. 6, the supply voltage V₀ supplied to the excitation coil 31 and the induced voltages V₁ and V₂ induced in the sine wave-shaped detection coil 32 and the cosine wave-shaped detection coil 33 are in phase. However, the induced voltage V₁ induced in the sine wave-shaped detection coil 32 switches between the in-phase and the reverse phase each time the target 2 passes through the position where the first curved portion 301a and the third curved portion 303a are crossing. In addition, the induced voltage V₂ induced in the cosine wave-shaped detection coil 33 switches each time the target 2 passes the position where the second curved portion 302a and the fourth curved portion 304a are crossing. A high-frequency AC voltage of, e.g., about 1 MHz to 1 GHz is supplied to the excitation coil 31 as a supply voltage V₀. The voltage is induced in the sine wave-shaped detection coil 32 and the cosine wave-shaped detection coil 33 by the AC magnetic field generated in the vicinity of the excitation coil 31.

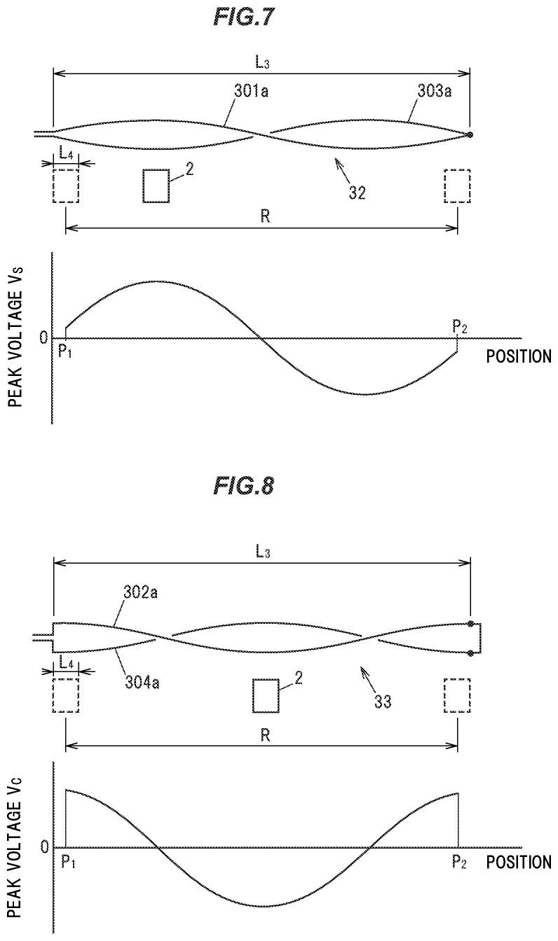

FIG. 7 is an explanatory diagram schematically showing the relationship between the peak voltage V_{S}, which is the peak value of the induced voltage V₁ induced in the sine wave-shaped detection coil 32, and the position of the target 2. FIG. 8 is an explanatory diagram schematically showing the relationship between the peak voltage V_{C}, which is the peak value of the induced voltage V₂ induced in the cosine wave-shaped detection coil 33, and the position of the target 2. In the graphs of the peak voltages V_{S} and V_{C} shown in FIGS. 7 and 8, the horizontal axis indicates the position of the target 2.

The stroke sensor 1 can detect an absolute position of the target 2 within an axial range R₂ in which the length L₄ of the target 2 in the longitudinal direction of the substrate 3 is subtracted from the length L₃ of the sine wave-shaped detection coil 32 and the cosine wave-shaped detection coil 33 in the longitudinal direction of the substrate 3. In the graphs shown in FIGS. 7 and 8, the peak voltages V_{S} and V_{C} are shown at respective positions where the horizontal axis coordinate when the target 2 is at one end (the end on the side of the calculation unit 5) of the axial range R₂ is P₁, and the horizontal axis coordinate when the target 2 is at the other end of the axial range R₂ is P₂. The original position of the horizontal axis is the position of the short side portion 313 of the excitation coil 31, indicated by point O₁ in FIG. 4.

Further, in the graphs shown in FIGS. 7 and 8, the peak voltage V_{S} of the sine wave-shaped detection coil 32 has a positive value when the induced voltage V₁ induced in the sine wave-shaped detection coil 32 is in phase with the supply voltage V₀ supplied to the excitation coil 31 and has a negative value when the phase is opposite. Similarly, the peak voltage V_{C} of the cosine wave-shaped detection coil 33 has a positive value when the induced voltage V₂ induced in the cosine wave-shaped detection coil 33 is in phase with the supply voltage V₀ supplied to the excitation coil 31, and has a negative value when the phase is opposite.

Here, if cox is defined as in Formula [1], the peak voltages V_{S} and V_{C} are obtained by Formula [2] and Formula [3], where Xp is the coordinate value of the horizontal axis of the target 2 in the graphs shown in FIGS. 7 and 8. Note that A in Formula [2] and Formula [3] is a predetermined constant.

$$[ Formula 1 ]$$

$${ω}_{x} = \frac{2 π}{{L}_{3}} \qquad [ 1 ]$$

$$[ Formula 2 ]$$

$$Vs = A sin \{ ( {ω}_{x} ( {X}_{p} - {L}_{1} ) \} \qquad [ 2 ]$$

$$[ Formula 3 ]$$

$$Vc = A cos \{ ( {ω}_{x} ( {X}_{p} - {L}_{1} ) \} \qquad [ 3 ]$$

From Formula [2] and Formula [3], the coordinate value Xp of the target 2 in the graphs shown in FIGS. 7 and 8 is obtained by Formula [4]. That is, the calculation unit 5 can calculate the position of the target 2 based on the peak voltages V_{S} and V_{C}.

$$[ Formula 4 ]$$

$${X}_{p} = \frac{arc tan ( \frac{{V}_{s}}{{V}_{c}} )}{{ω}_{x}} + {L}_{1} \qquad [ 4 ]$$

By the way, if a steel material constituting the vehicle body, for example, is placed in a part of the range of the magnetic field generated by energizing the excitation coil 31, the presence of the steel material changes the intensity of the magnetic field in the sine wave-shaped detection coil 32 and cosine wave-shaped detection coil 33, and the detection accuracy of the position of the rack shaft 13 may decline depending on the amount of change.

Therefore, in the present embodiment, the shield conductor 41 as a magnetic field diffusion suppression member that suppresses the spread of the magnetic field generated by energizing the excitation coil 31 is placed in the case member 6 together with the substrate 3. By placing the shield conductor 41 near the substrate 3, even if a member such as a steel material that affects the magnetic field is placed at a position on the opposite side of the shield conductor 41 from the substrate 3, the effect of the member on the magnetic flux density of the magnetic field interlinked with the sine wave-shaped detection coil 32 and the cosine wave-shaped detection coil 33 is suppressed. This can suppress the decline in the detection accuracy of the position of the rack shaft 13. In addition, by arranging the shield conductor 41, it is possible to suppress the magnetic flux of the magnetic field generated by the electric current supplied to the electric motor as the drive source of the vehicle, for example, from being interlinked to the sine wave-shaped detection coil 32 and the cosine wave-shaped detection coil 33.

The shield conductor 41 is arranged to cover the entire area between the pair of long side portions 311, 312 of the excitation coil 31 in the substrate 3. In FIG. 4, the outline of the shield conductor 41 when viewed from a direction perpendicular to the substrate 3 is shown as a double-dashed line. The size of the shield conductor 41 is larger than the size of the coil portion 3A in the substrate 3, and the entire coil portion 3A is covered by the shield conductor 41.

By arranging the shield conductor 41, for example, at a distance of 8 mm from the back surface 3b of the substrate 3, the detection error of the position of the rack shaft 13 can be reduced by two-thirds or less, when the conductor is located at a distance of 10 mm in the normal direction from the back surface 3b of the substrate 3.

### First Modified Example of Magnetic Field Diffusion Suppression Member

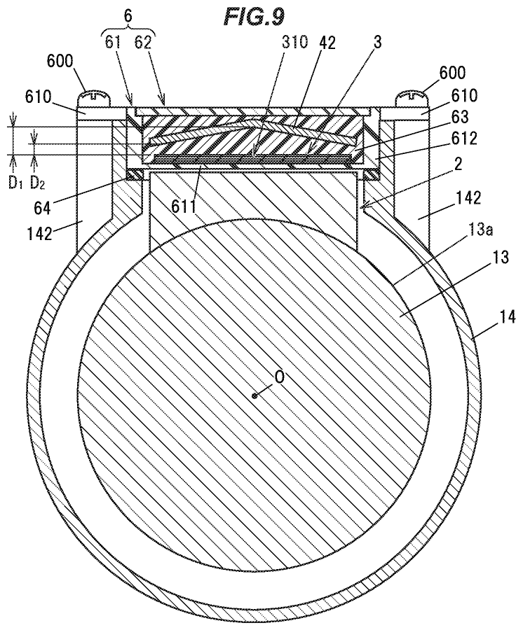

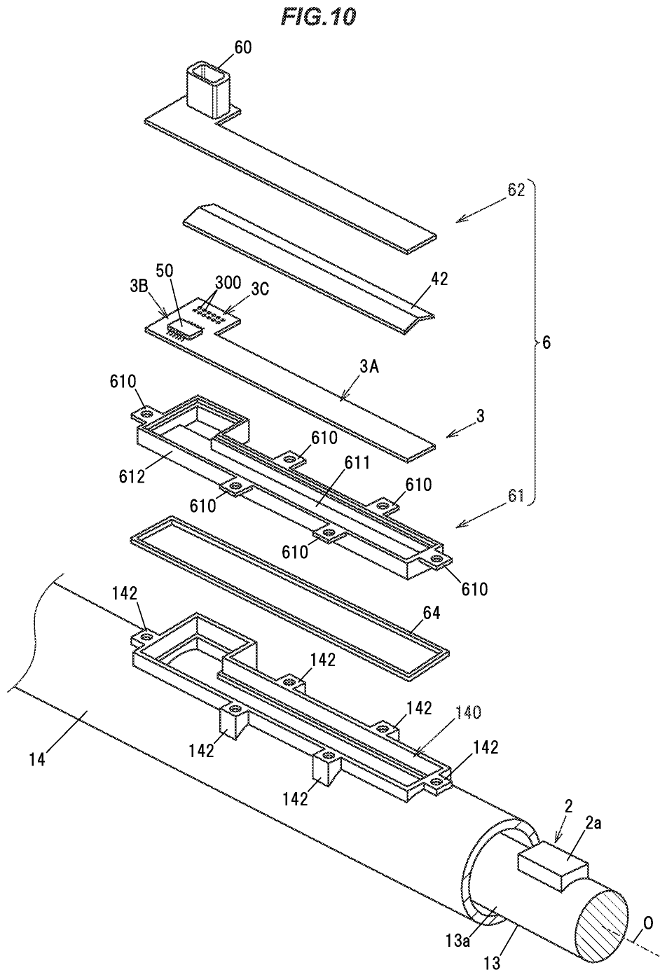

FIG. 9 is a cross-sectional view of a shield conductor 42 according to the first modified example and its peripheral parts. FIG. 10 is a perspective view showing the shield conductor 42 according to the first modified example, together with the target 2, the substrate 3, the CPU 50, the case member 6, the rack shaft 13, and a part of the housing 14.

This shield conductor 42, like the shield conductor 41 above, is made of electrically conductive metal such as copper or aluminum, and is positioned between the substrate 3 and the case lid 62 to cover the entire area between the pair of long side portions 311, 312 of the excitation coil 31 in the substrate 3, but the shape of the shield conductor 42 is different from that of the shield conductor 41. The shield conductor 42 is mountainous in shape with a distance D₁ between a middle portion 310 of the pair of long side portions 311, 312 in the substrate 3 being longer than a distance D₂ between the pair of long side portions 311, 312. The middle portion 310 is the portion that corresponds to the central axis C shown in FIG. 4.

According to this shield conductor 42, the uniformity of the magnetic flux density of the magnetic field between the pair of long side portions 311, 312 of the substrate 3 is increased, and the detection accuracy of the position of the rack shaft 13 can be improved. In other words, the magnetic flux density of the magnetic field between the pair of long side portions 311, 312 decreases with the distance from each of the long side portions 311, 312, but by arranging the shield conductor 42 as shown in FIG. 9, the magnetic field of the excitation coil 31 is weakened by the shield conductor 42. The uniformity of the magnetic flux density of the magnetic field in the area where the sine wave-shaped detection coil 32 and the cosine wave-shaped detection coil 33 are formed is enhanced by weakening the magnetic field of the excitation coil 31 in the middle portion 310 of the pair of long side portions 311 and 312. This further enhances the detection accuracy of the position of the rack shaft 13 compared to the case where a flat plate-shaped shield conductor 41 is used.

In the examples shown in FIGS. 9 and 10, the shape of the shield conductor 42 viewed from the longitudinal direction of the substrate 3 is mountainous as described above, but it is not limited to mountainous shape, for example, it can be curved in a bow shape if it has the relationship D₁>D₂.

### Second Modified Example of Magnetic Field Diffusion Suppression Member

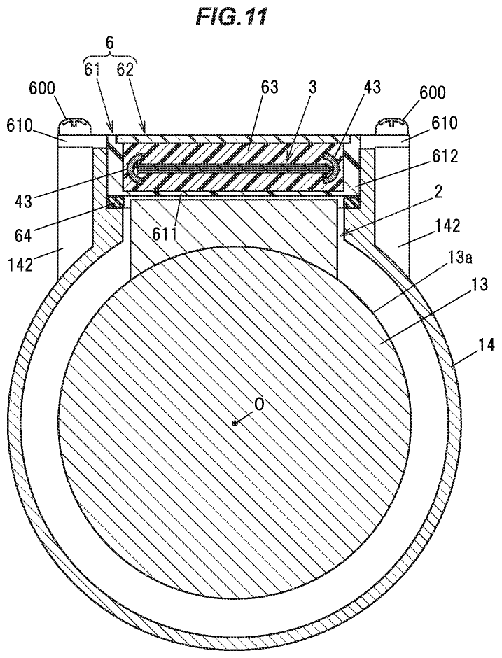

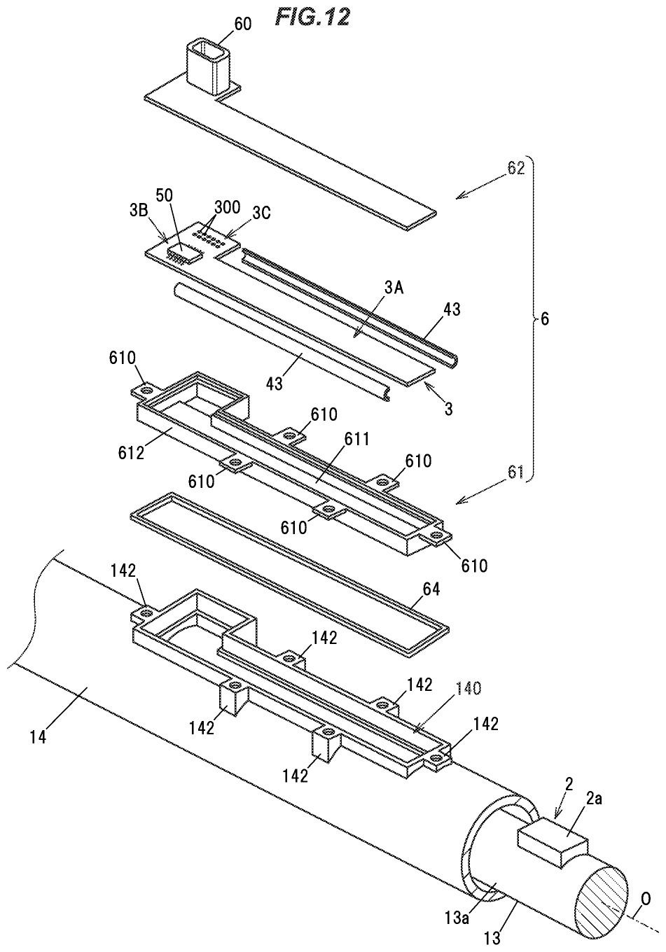

FIG. 11 is a cross-sectional view of a pair of magnetic elements 43 as magnetic field diffusion suppression member according to the second modified example and its peripheral parts. FIG. 12 is a perspective view showing the pair of magnetic elements 43 according to the second modified example, together with the target 2, the substrate 3, the CPU 50, the case member 6, the rack shaft 13, and a part of the housing 14.

The pair of magnetic elements 43 are arranged in an area that includes a position across the coil portion 3A of the substrate 3 in its shortitudinal direction. Each magnetic element 43 has a higher magnetic permeability than the rack shaft 13 and is composed of, e.g., a ferrite. In the examples shown in FIGS. 11 and 12, the magnetic elements 43 viewed from the longitudinal direction of the substrate 3 are semicircular, but they may be rectangular, for example, long in the thickness direction of the substrate 3. Although it is desirable to arrange two magnetic elements 43 so as to sandwich the coil portion 3A of the substrate 3, a single magnetic element 43 may be arranged in a position aligned with the coil portion 3A of the substrate 3 in its shortitudinal direction.

Even when the magnetic element 43 according to the second modified example is used, the influence of steel and other materials placed around the stroke sensor 1 on the magnetic flux density of the magnetic field interlinked to the sine wave-shaped detection coil 32 and the cosine wave-shaped detection coil 33 is suppressed, and the decline in detection accuracy of the position of the rack shaft 13 can be suppressed.

### Summary of Embodiment and Modified Example

Next, technical ideas understood from the embodiment and modified examples described above will be described with reference to the reference numerals and the like in the embodiment and modified examples. However, each reference numeral in the following description does not limit the constituent elements in the claims to the members and the like specifically shown in the embodiment and modified examples.

According to the first feature, a position detection device (stroke sensor) 1 for detecting a position of a moving member (rack shaft) 13 moving forward and backward in a predetermined moving direction, includes a detection object (target) 2 provided at the moving member 13, a substrate 3 provided with an excitation coil 31 for generating a magnetic field in an area including the detection object 2, and a detection coil 32, 33 being interlinked with a magnetic flux of the magnetic field, a power supply unit 7 for supplying an alternating current to the excitation coil 31, a calculation unit 5 that calculates the position of the moving member 13 based on an output voltage of the detection coil 32, 33, and a magnetic field diffusion suppression member (shield conductor) 41, 42, (magnetic element) 43 for suppressing a spread of a magnetic field generated by energization to the excitation coil 31.

According to the second feature, in the position detection device 1 as described by the first feature, the detection object 2 is arranged on one side of the substrate 3 and the magnetic field diffusion suppression member 41, 42, 43 is arranged on the other side of the substrate 3, among one side and the other side perpendicular to the substrate 3.

According to the third feature, in the position detection device 1 as described by the second feature, the excitation coil 31 has a pair of long side portions 311, 312 extending parallel to the moving direction of the moving member 13, the detection coil 32, 33 is disposed between the pair of long side portions 311, 312, and the magnetic field diffusion suppression member 41, 42 is arranged to cover an entire area between the pair of long side portions 311, 312 on the substrate 3.

According to the fourth feature, in the position detection device 1 as described by the third feature, a distance D₁ between a middle portion 310 between the pair of long side portions 311, 312 and the magnetic field diffusion suppression member 42 in the substrate 3 is longer than a distance D₂ between each of the pair of long side portions 311, 312 and the magnetic field diffusion suppression member 42.

According to the fifth feature, in the position detection device 1 as described by the first feature, the substrate 3 includes a rectangular-shaped portion (coil portion) 3A formed with the excitation coil 31 and the detection coil 32, 33 which is long in the moving direction of movement of the moving member 13, and the magnetic field diffusion suppression member 43 is disposed in a range including a position across the rectangular-shaped portion 3A of the substrate 3 in its shortitudinal direction.

According to the sixth feature, in the position detection device 1 as described by any one of the first to fifth features, the magnetic field diffusion suppression member 41, 42, 43 is composed of a conductive metal or a magnetic material with higher magnetic permeability than the moving member.

According to the seventh feature, in the position detection device 1 as described by the first feature, the detection coil 32, 33 is composed of two detection coils 32, 33 provided on the substrate 3, and phases of the voltages induced in the respective two detection coils 32, 33 while the moving member 13 moves from one moving end to the other moving end are different from each other.

According to the eighth feature, in the position detection device 1 as described by the first feature, the moving member 13 is a rack shaft of a steering device 10 of a vehicle.

Although the embodiment and modified example of the present invention has been described above, the embodiment and modified example described above do not limit the invention according to the scope of claims. Also, it should be noted that not all combinations of features described in the embodiment and modified example are essential to the means for solving the problems of the invention. In addition, the invention can be implemented by modifying it as appropriate to the extent that it does not depart from the gist of the invention, for example, it can be implemented by the following modifications.

In the above embodiment, the case where the target 2 as the detection object is made of a material with higher electrical conductivity than the rack shaft 13 is described, but it is not limited to this case. For example, the detection object may be made of a magnetic material with higher magnetic permeability than the rack shaft 13. In this case, the magnetic flux is concentrated in the detection object and the position of the detection object relative to the substrate 3 can be detected because the magnetic flux density in the portion of the substrate 3 facing the detection object is higher than in other portions.

The moving member as the detection object whose position is to be detected by the stroke sensor 1 is not limited to the rack shaft 13 of the steering device 10, but may be an automotive or non-automotive shaft or the like. The shape of the moving member is not limited to a cylindrical shape, but may be a long plate shape, for example.

1. A position detection device for detecting a position of a moving member moving forward and backward in a predetermined moving direction, comprising:
a detection object provided at the moving member;
a substrate provided with an excitation coil for generating a magnetic field in an area including the detection object, and a detection coil being interlinked with a magnetic flux of the magnetic field;
a power supply unit for supplying an alternating current to the excitation coil;
a calculation unit that calculates the position of the moving member based on an output voltage of the detection coil; and
a magnetic field diffusion suppression member for suppressing a spread of a magnetic field generated by energization to the excitation coil.

2. The position detection device, according to claim 1, wherein the detection object is arranged on one side of the substrate and the magnetic field diffusion suppression member is arranged on an other side of the substrate, among one side and the other side perpendicular to the substrate.

3. The position detection device, according to claim 2, wherein the excitation coil comprises a pair of long side portions extending parallel to the moving direction of the moving member,
wherein the detection coil is disposed between the pair of long side portions, and
wherein the magnetic field diffusion suppression member is arranged to cover an entire area between the pair of long side portions on the substrate.

4. The position detection device, according to claim 3, wherein a distance between a middle portion between the pair of long side portions and the magnetic field diffusion suppression member in the substrate is longer than a distance between each of the pair of long side portions and the magnetic field diffusion suppression member.

5. The position detection device, according to claim 1, wherein the substrate includes a rectangular-shaped portion formed with the excitation coil and the detection coil which is long in the moving direction of movement of the moving member, and
wherein the magnetic field diffusion suppression member is disposed in a range including a position across the rectangular-shaped portion of the substrate in its shortitudinal direction.

6. The position detection device, according to claim 1, wherein the magnetic field diffusion suppression member comprises a conductive metal or a magnetic material with higher magnetic permeability than the moving member.

7. The position detection device, according to claim 1, wherein the detection coil comprises two detection coils provided on the substrate, and phases of the voltages induced in the respective two detection coils while the moving member moves from one moving end to the other moving end are different from each other.

8. The position detection device, according to claim 1, wherein the moving member is a rack shaft of a steering device of a vehicle.
